(19) United States
(12) Patent Application Publication
(10) Pub. No.: US 2017/0019518 A1
(43) Pub. Date: Jan. 19, 2017

(54) METHOD AND APPARATUS FOR CONTROLLING DEVICES

(71) Applicant: Xiaomi Inc., Beijing (CN)

(72) Inventors: Yuanbo WANG, Beijing (CN); Hao CHEN, Beijing (CN); Enxing HOU, Beijing (CN)

(21) Appl. No.: 15/199,123

(22) Filed: Jun. 30, 2016

(30) Foreign Application Priority Data
Jul. 13, 2015 (CN) 201510409114.6

(51) Int. Cl. H04M 1/725; H04L 12/28; H04L 29/08; H04W 8/24; H04W 8/20

(52) U.S. Cl. CPC H04M 1/7253; H04W 8/245; H04W 8/20; H04L 67/12; H04L 12/2818; H04L 2012/2841

(57) ABSTRACT

The present disclosure relates to a method and an apparatus for controlling a device. The method includes obtaining model identification information of a device to be controlled. The model identification information is used for identifying a manufacturer and a device type of the device to be controlled. The method also includes obtaining a control interface for controlling a device of the device type manufactured by the manufacturer based on the model identification information. The method further includes controlling the device to be controlled via the control interface.

### CROSS-REFERENCE TO RELATED APPLICATIONS

The present application is based upon and claims priority to Chinese Patent Application No. 201510409114.6, filed Jul. 13, 2015, the entire contents of which are incorporated herein by reference.

### TECHNICAL FIELD

The present disclosure generally relates to communication and, more particularly, to a method and an apparatus for controlling devices.

### BACKGROUND

The Internet of Things is a network of connected physical objects. Many household electronic devices can be connected to the Internet of Things, through which a user can control household electronic devices via his/her mobile phone. This brings much convenience to the user. For example, before returning home from work, a user can turn on an air conditioner in his/her home via his/her mobile phone in advance for cooling the home. When the user arrives at his/her home, the home is already cooled down to a comfortable level.

In related art, a mobile phone application (APP) is provided for controlling electronic devices. The APP includes a general control interface that includes basic control functions for controlling various devices. A user can open the general control interface of the APP in the mobile phone and control various devices in his/her home via the general control interface.

### SUMMARY

Embodiments of the present disclosure provide a method and an apparatus for controlling a device. The technical solutions are as follows.

According to a first aspect of embodiments of the present disclosure, there is provided a method for controlling a device. The method includes obtaining model identification information of a device to be controlled. The model identification information is used for identifying a manufacturer and a device type of the device to be controlled. The method also includes obtaining a control interface for controlling a device of the device type manufactured by the manufacturer based on the model identification information. The method further includes controlling the device to be controlled via the control interface.

According to a second aspect of embodiments of the present disclosure, there is provided an apparatus for controlling a device. The apparatus includes a processor and a memory for storing instructions executable by the processor. The processor is configured to obtain model identification information of a device to be controlled. The model identification information is used for identifying a manufacturer and a device type of the device to be controlled. The processor is also configured to obtain a control interface for controlling a device of the device type manufactured by the manufacturer based on the model identification information. The processor is further configured to control the device to be controlled via the control interface.

According to a third aspect of embodiments of present disclosure, there is provided a non-transitory computer-readable storage medium. The non-transitory computer-readable storage medium stores instructions that, when executed by a processor in an apparatus for controlling a device, cause the apparatus to perform a method that includes obtaining model identification information of a device to be controlled. The model identification information is used for identifying a manufacturer and a device type of the device to be controlled. The method also includes obtaining a control interface for controlling a device of the device type manufactured by the manufacturer based on the model identification information. The method further includes controlling the device to be controlled via the control interface.

The technical solutions provided by embodiments of the present disclosure may have the following advantageous effects:

A corresponding control interface is obtained according to model identification information of a device to be controlled. The model identification information is used for identifying a manufacturer and a device type of the device to be controlled, and the control interface is used for controlling various functions of a device of the device type manufactured by the manufacturer. Thus, various functions of the device to be controlled can be controlled via the control interface.

It is to be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flowchart showing a method for controlling a device according to an exemplary embodiment;

FIG. 2A is a flowchart showing a method for controlling a device according to another exemplary embodiment;

FIG. 2B is a diagram schematically illustrating a display interface according to another exemplary embodiment;

FIG. 3 is a block diagram showing an apparatus for controlling a device according to another exemplary embodiment; and

FIG. 4 is a block diagram showing an apparatus for controlling a device according to another exemplary embodiment.

Specific embodiments of the present disclosure are shown in the above drawings, more detailed descriptions of which are provided below. These drawings and the corresponding descriptions are not intended to restrict the scope of the invention in any manner, but for illustrating the various embodiments of the invention to one of ordinary skill in this art.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of devices and methods consistent with aspects related to the present disclosure as recited in the appended claims.

A mobile terminal can run an application (or APP) for controlling devices. The application includes one or more user interfaces for a user to perform operations, such as viewing, managing, or controlling the devices. Optionally, the application further includes one or more user interfaces for a user to browse, collect, or purchase the devices. Optionally, the user interface through which a user can perform operations, such as viewing, managing, or controlling the devices, includes a device list associated with the devices. The device list records information related to the devices that the user can operate, or that are owned by the user (for example, information such as the names, brief introductions, operation status of the devices). In some embodiments of the present disclosure, the devices are smart devices. For example, if a user manages an air purifier or a user owns a smart air purifier, the air purifier may appear in a device list corresponding to an account of the user.

At present, in related art, a user can install an APP for controlling a device in a mobile terminal. The APP includes a general control interface corresponding to each device type. The general control interface corresponding to each device type provides control of basic functions corresponding to the device type. The user can control the basic functions corresponding to the device type via the general control interface. For example, if the APP includes a general control interface corresponding to an air conditioner, the general control interface can provide control of the basic functions of the air conditioner, such as, turning on and off the refrigeration function of the air conditioner. The user can open the general control interface provided with the mobile terminal and turn on or off the refrigeration function of the air conditioner via the general control interface.

However, for devices of the same device type but manufactured by different manufacturers, they may have different device models. The devices having different device models may have different functions. For example, in addition to the basic functions corresponding to the device type, a device of a particular device model may have a unique function corresponding to the device model. The general control interface does not provide control of the unique function. As a result, a user cannot control the unique function through the general control interface. For example, an air conditioner of a certain model manufactured by a manufacturer may include a unique air purifying function. The general control interface of the air conditioner, however, can control only turning on and off the refrigeration function of the air conditioner, and cannot control the unique function, for example, turning on or off the air purifying function of the air conditioner. As a result, a user cannot control the air purifying function via the general control interface.

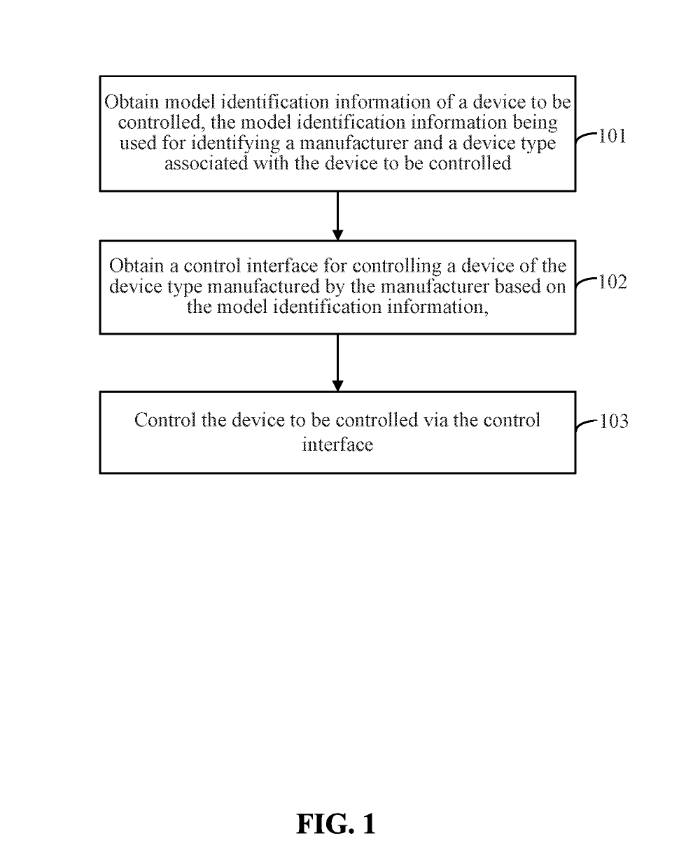

FIG. 1 is a flowchart showing a method for controlling a device according to an exemplary embodiment. The method includes the following steps.

In step 101, model identification information of a device to be controlled is obtained. The model identification information is used for identifying a manufacturer and a device type associated with the device to be controlled.

In step 102, a control interface for controlling a device of the device type manufactured by the manufacturer is obtained based on the model identification information.

In step 103, the device to be controlled is controlled via the control interface.

In embodiments of the present disclosure, a corresponding control interface is obtained according to model identification information of a device to be controlled. The model identification information is used for identifying a manufacturer and a device type of the device to be controlled. The control interface is used for controlling various functions of a device of the device type manufactured by the manufacturer. As a result, various functions of the device to be controlled can be controlled via the control interface.

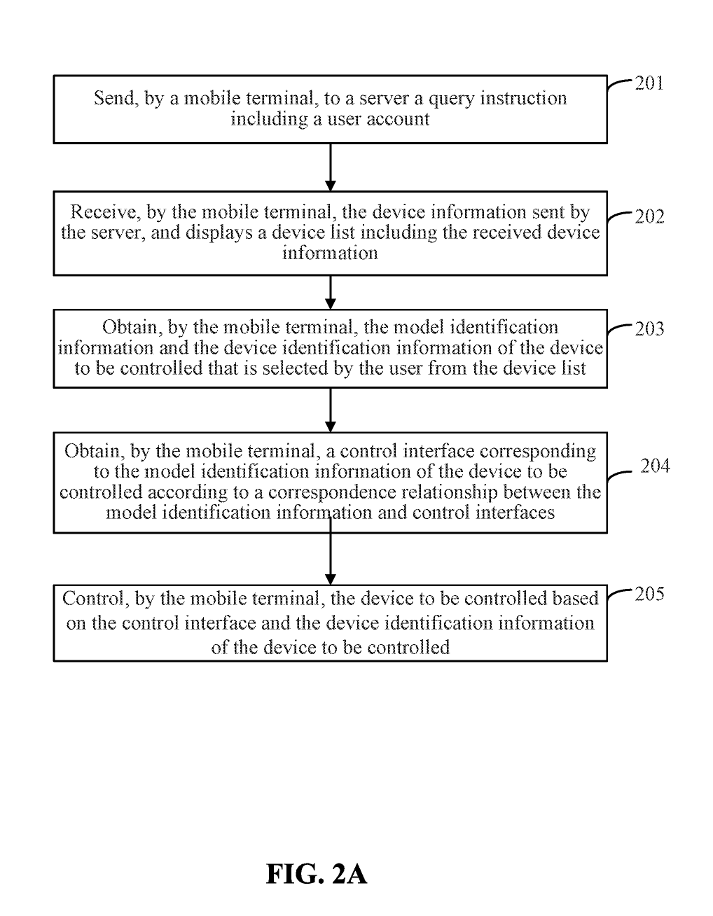

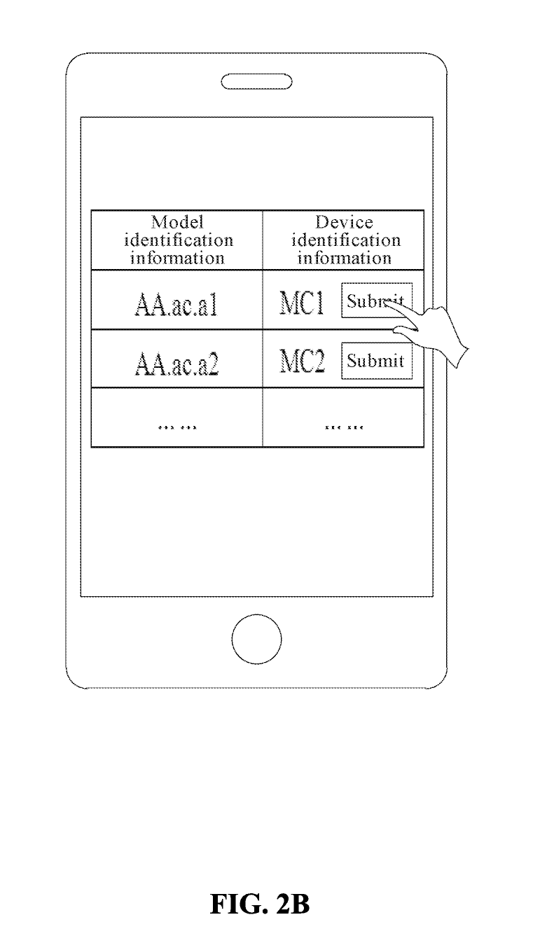

FIG. 2A is a flowchart showing a method for controlling a device according to another exemplary embodiment. The present embodiment may be performed by a mobile terminal, which may be a mobile phone, a tablet computer, a Personal Digital Assistant (PDA), a handheld computer, and the like.

In the present embodiment, the mobile terminal obtains the control interfaces of respective devices and controls the respective devices via the respective control interfaces. A Microcontroller Unit (MCU) of each device to be controlled includes a model field. The model field in the MCU of each device is configured to store model identification information of the device. The model identification information includes at least information related to the manufacturer of the device and information related to the device type of the device. That is, the model identification information is used for identifying the manufacturer and the device type of the device. The model identification information can further include information related to a device model of the device. That is, the model identification information is further used for identifying the device model of the device. The information related to the manufacturer of the device can include the name of the manufacturer and the like. For example, for an air conditioner, the model identification information of the air conditioner can be “AA. ac. a1,” where the portion “AA” represents information related to the manufacturer of the air conditioner, the portion “ac” represents information related to the device type of the air conditioner, i.e., an air conditioner. The portion “a1” represents information related to the device model of the air conditioner. The model identification information “AC. ac. a1” indicates that the device is an air conditioner manufactured by the manufacturer “AA,” and the device model of the air conditioner is “a1.”

For each device, when connecting to a server, the device can send device description information to the server. The device description information includes a user account associated with the device, and device information of the device. The device information includes the model identification information stored in the model field and device identification information of the device. The device information can further include one or more of the name of the device, the manufacturer of the device, the device type, the operation status of the device, and the like. The server receives the device description information sent from the device, and stores the device information included in the device description information in a device information list corresponding to the user account. The device identification information of the device can include a Media Access Control (MAC) address, an Internet Protocol (IP) address, and the like of the device.

For example, for the above described air conditioner, when connecting to a server, the air conditioner sends device description information to the server. The device description information includes a user account ID1 associated with the air conditioner and device information of the air conditioner. The device information includes the model identification information “AA. ac. a1” of the air conditioner and the device identification information “MAC1” of the air conditioner. The server receives the device description information, and obtains a corresponding device information list according to the user account ID1 included in the device description information. The device information list is configured to store device information related to the devices associated with the user account ID1. The server stores the device information of the air conditioner included in the device description information into the device information list, as shown in Table 1. That is, the server stores the model identification information “AA. ac. a1” and the device identification information “MAC1” included in the device information in the device information list shown in Table 1.

TABLE 1

| Model identification information | Device identification information |
|---|---|
| AA. ac. a1 | MAC1 |
| AA. ac. a2 | MAC2 |
| . . . | . . . |

An APP for controlling devices is installed in a mobile terminal. The APP stores a correspondence relationship between model identification information and control interfaces. The correspondence relationship between model identification information and control interfaces includes model identification information and control interfaces corresponding to various devices manufactured by different manufacturers. In the correspondence relationship between model identification information and control interfaces, if the model identification information includes information related to a manufacturer and information related to a device type, the control interface corresponding to the model identification information is dedicated to controlling devices of the device type manufactured by the manufacturer. If the model identification information further includes information related to a device model, the control interface corresponding to the model identification information is dedicated to controlling devices of the device model manufactured by the manufacturer and of the device type.

For example, referring to Table 2, the correspondence relationship between model identification information and control interfaces is established in advance by technicians and stored in a server. Each time when a manufacturer develops a device of a specific device model, the technicians create a control interface corresponding to the developed device. The control interface provides control of all of the functions of the developed device. The technicians store the model identification information and the control interface corresponding to the developed device in the correspondence relationship between model identification information and control interfaces. A mobile terminal can download the correspondence relationship between model identification information and control interfaces from a server at any time (e.g., regularly or irregularly) to update the correspondence relationship between model identification information and control interfaces stored in the mobile terminal.

In the correspondence relationship between model identification information and control interfaces shown in Table 2, a control interface 1 corresponding to the model identification information “AA. ac. a1” is dedicated to controlling air conditioners of a device model “a1” manufactured by a manufacturer “AA.” A control interface 2 corresponding to the model identification information “AA. ac. a2” is dedicated to controlling air conditioners of a device model “a2” manufactured by the manufacturer “AA.”

TABLE 2

| Model identification information | Control interface |
|---|---|
| AA. ac. a1 | Control interface 1 |
| AA. ac. a2 | Control interface 2 |
| . . . | . . . |

Referring to FIG. 2A, the disclosed method includes the following steps.

In step 201, a mobile terminal sends to a server a query instruction including a user account.

The user account is stored in the mobile terminal. When a user desires to control a device associated with his/her user account, the user starts an APP installed in the mobile terminal and configured for controlling devices. The mobile terminal sends a query instruction including the user account to a server. The server receives the query instruction, and obtains corresponding device information according to the user account included in the query instruction. The device information includes model identification information and device identification information of devices associated with the user account. In some embodiments, the device information further includes one or more of the names, manufacturers, types, operation status of the devices, and the like. The device information is sent to the mobile terminal by the server.

For example, after the user starts the APP in the mobile terminal for controlling devices, the mobile terminal obtains the user account ID1, and sends to the server a query instruction including the user account ID1. The server receives the query instruction, obtains the device information included in the corresponding Table 1 based on the user account ID1 included in the query instruction, and sends the device information to the mobile terminal.

In step 202, the mobile terminal receives the device information sent by the server and displays a device list including the received device information.

The device information includes the model identification information and the device identification information of devices. After the mobile terminal displays the device information to the user, the user selects a certain device to be controlled from the device list showing the device information, through which selection the App obtains the model identification information and the device identification information of the selected device. The user then submits the model identification information and the device identification information to the mobile terminal.

For example, the mobile terminal receives the device information shown in Table 1 sent from the server, and displays a device list including the received device information, as shown in FIG. 2B. The device list may show one or more of the names, the identifications, the model identification information, the manufacturers, the types, the device model information, the operation status of the devices associated with the user account. In the displayed device list, the device information of each device further corresponds to a submission button. The user can tap the submission button corresponding to a certain device to submit the model identification information and the device identification information of the device to the mobile terminal as the model identification information and the device identification information of the device to be controlled. For example, if the user taps the first submission button in the device list, the model identification information “AA. ac. a1” and the device identification information “MAC1” are submitted to the mobile terminal.

In step 203, the mobile terminal obtains the model identification information and the device identification information of the device to be controlled that is selected by the user from the device list.

For example, the mobile terminal obtains the model identification information and the device identification information as “AA. ac. a1” and “MAC1,” as shown in FIG. 2B.

In step 204, the mobile terminal obtains a control interface corresponding to the model identification information of the device to be controlled according to the correspondence relationship between the model identification information and control interfaces.

For example, the mobile terminal obtains a corresponding control interface 1 from the correspondence relationship between model identification information and control interfaces based on the model identification information “AA. ac. a1,” as shown in Table 2.

In step 205, the mobile terminal controls the device to be controlled based on the control interface and the device identification information of the device to be controlled.

The control interface includes control ports for controlling various functions of the device to be controlled. A user can trigger a control instruction to be input to the mobile terminal by operating a control port corresponding to a specific function in the control interface. The mobile terminal in turn sends a control instruction to the device to be controlled according to the device identification information of the device to be controlled, causing the device to be controlled to execute the control instruction.

In embodiments of the present disclosure, if the model identification information includes information related to a manufacturer and information related to a device type, the control interface corresponding to the model identification information is dedicated to controlling devices of the device type manufactured by the manufacturer. The control interface can provide control of all of the functions of the devices of the device type manufactured by the manufacturer. If the model identification information further includes information related to a device model, the control interface corresponding to the model identification information is dedicated to controlling of devices of the device model. The control interface can provide control of all of the functions of the device of the device model. Thus, when a mobile terminal controls a device, a control interface dedicated to controlling of the device can be obtained based on the model identification information of the device, and all of the functions of the device can be controlled via the control interface.

The following are embodiments of the apparatus of the present disclosure that is configured to perform the disclosed methods. For any operation performed by the apparatus that is not described below, one can refer to the above discussions of the disclosed methods.

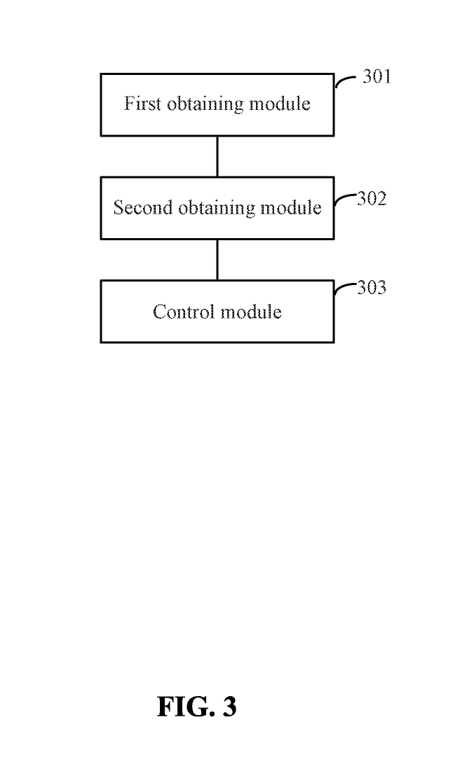

FIG. 3 is a block diagram showing an apparatus for controlling a device according to another exemplary embodiment. The apparatus includes a first obtaining module 301 configured to obtain model identification information of a device to be controlled. The model identification information is used for identifying a manufacturer and a device type of the device to be controlled. The apparatus also includes a second obtaining module 302 configured to obtain, based on the model identification information, a control interface for controlling a device of the device type manufactured by the manufacturer. The apparatus further includes a control module 303 configured to control the device to be controlled via the control interface.

Optionally, the first obtaining module 301 includes a sending unit configured to send to a server a query instruction including a user account. The first obtaining module 301 includes a receiving unit configured to receive device information sent by the server. The device information includes model identification information of devices associated with the user account. The first obtaining module 301 also includes an obtaining unit configured to obtain the model identification information of the device to be controlled that is selected by a user from a device list. The device list displays the received device information.

Optionally, the second obtaining module 302 is configured to obtain a control interface corresponding to the model identification information according to a correspondence relationship between model identification information and control interfaces.

Optionally, the model identification information includes at least information related to the manufacturer and information related to the device type of the device to be controlled.

Optionally, the model identification information further includes information related to a device model of the device to be controlled.

Optionally, the device information of devices associated with the user account sent by the server is determined by the server according to device information entered by the user, or is determined by the server based on received device information sent by the devices associated with the user account.

In embodiments of the present disclosure, a corresponding control interface is obtained according to model identification information of a device to be controlled. The model identification information is used for identifying a manufacturer and a device type of the device to be controlled. The control interface is used for controlling various functions of a device of the device type manufactured by the manufacturer. Thus, various functions of the device to be controlled can be controlled via the control interface.

The specific operations performed by the modules included in the disclosed apparatus have been described above in the discussion of the embodiments of the disclosed methods. Therefore, detailed descriptions of the operations performed by the modules are not repeated.

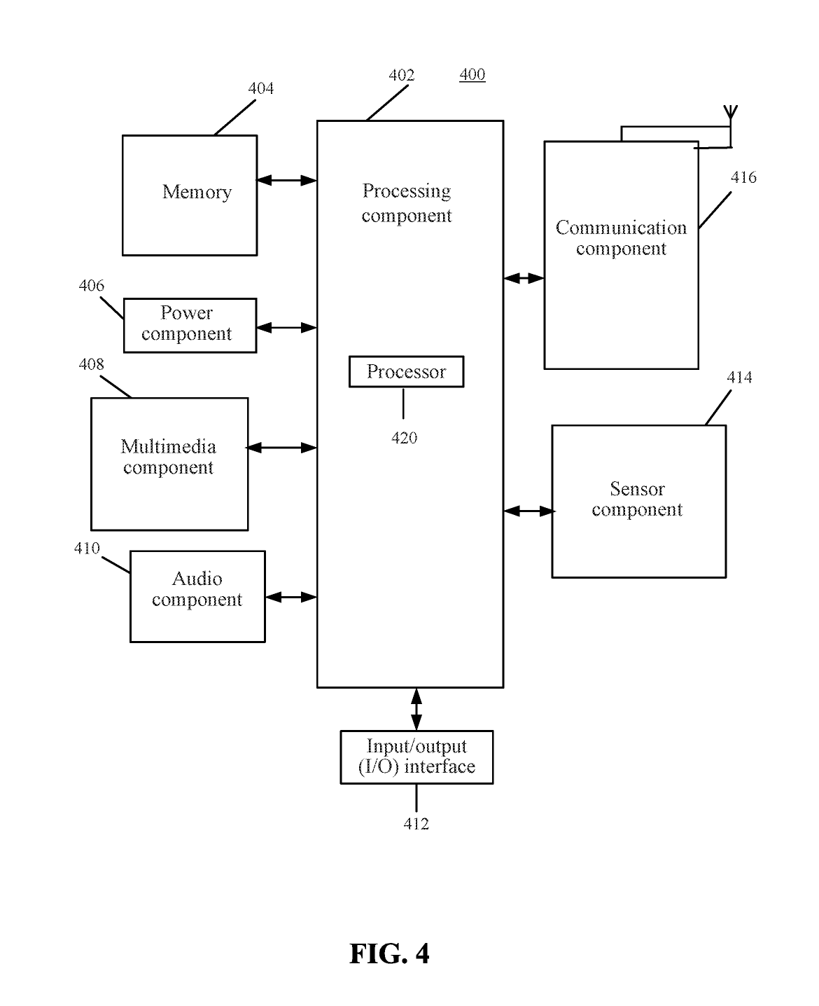

FIG. 4 is a block diagram showing an apparatus 400 for controlling a device according to another exemplary embodiment. For example, the apparatus 400 may be a mobile phone, a computer, a digital broadcast terminal, a messaging device, a gaming console, a tablet, a medical device, exercise equipment, a personal digital assistant, and the like.

Referring to FIG. 4, the apparatus 400 includes one or more of the following components: a processing component 402, a memory 404, a power component 406, a multimedia component 408, an audio component 410, an input/output (I/O) interface 412, a sensor component 414, and a communication component 416.

The processing component 402 is configured to control overall operations of the apparatus 400, such as operations associated with display, telephone calls, and data communications, camera operations, and recording operations. The processing component 402 includes one or more processors 420 configured to execute instructions to perform all or part of the above described methods. The processing component 402 includes one or more modules configured to facilitate the interaction between the processing component 402 and other components. For example, in some embodiments, the processing component 402 includes a multimedia module configured to facilitate the interaction between the multimedia component 408 and the processing component 402.

The memory 404 is configured to store various types of data to support the operation of the apparatus 400. Examples of such data include instructions for the applications or methods executed or performed by the apparatus 400, contact data, phonebook data, messages, pictures, video, etc. The memory 404 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, and a magnetic or optical disk.

The power component 406 is configured to provide power to various components of the apparatus 400. The power component 406 includes a power management system, one or more power sources, and any other components associated with the generation, management, and distribution of power in the apparatus 400.

The multimedia component 408 includes a screen providing an output interface between the apparatus 400 and the user. In some embodiments, the screen includes a liquid crystal display and a touch panel. If the screen includes the touch panel, the screen can be implemented as a touch screen to receive input signals from the user. The touch panel includes one or more touch sensors configured to sense touches, swipes, and gestures on the touch panel. The touch sensors not only sense a boundary of a touch or swipe action, but also sense a period of time and a pressure associated with the touch or swipe action. In some embodiments, the multimedia component 408 includes a front camera and/or a rear camera. The front camera and the rear camera are configured to receive external multimedia data while the apparatus 400 is in an operation mode, such as a photographing mode or a video mode. Each of the front camera and the rear camera can be a fixed optical lens system or can have focus and optical zoom capability.

The audio component 410 is configured to output and/or input audio signals. For example, the audio component 410 includes a microphone configured to receive an external audio signal when the apparatus 400 is in an operation mode, such as a call mode, a recording mode, and a voice recognition mode. The received audio signal can be further stored in the memory 404 or transmitted via the communication component 416. In some embodiments, the audio component 410 further includes a speaker to output audio signals.

The I/O interface 412 is configured to provide an interface between the processing component 402 and peripheral interface modules, such as a keyboard, a click wheel, buttons, and the like. The buttons may include, but are not limited to, a home button, a volume button, a starting button, and a locking button.

The sensor component 414 includes one or more sensors configured to provide status assessments of various aspects of the apparatus 400. For example, in some embodiments, the sensor component 414 is configured to detect at least one of an open/closed status of the apparatus 400, relative positioning of components, e.g., the display and the keypad, of the apparatus 400, a change in position of the apparatus 400 or a component of the apparatus 400, a presence or absence of user contact with the apparatus 400, an orientation or an acceleration/deceleration of the apparatus 400, and a change in temperature of the apparatus 400. In some embodiments, the sensor component 414 includes a proximity sensor configured to detect the presence of nearby objects without any physical contact. In some embodiments, the sensor component 414 includes a light sensor, such as a CMOS or CCD image sensor, for use in imaging applications. In some embodiments, the sensor component 414 also includes at least one of an accelerometer sensor, a gyroscope sensor, a magnetic sensor, a pressure sensor, or a temperature sensor.

The communication component 416 is configured to facilitate wired or wireless communication between the apparatus 400 and other devices. The apparatus 400 can access a wireless network based on a communication standard, such as WiFi, 2G, or 3G, or a combination thereof. In some embodiments, the communication component 416 receives a broadcast signal or broadcast associated information from an external broadcast management system via a broadcast channel. In some embodiments, the communication component 416 further includes a near field communication (NFC) module configured to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 400 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 404, executable by the processor 420 in the apparatus 400, for performing the above-described methods. For example, the non-transitory computer-readable storage medium may be a ROM, a RAM, a CD-ROM, a magnetic tape, a floppy disc, an optical data storage device, and the like.

When instructions stored in the storage medium are executed by a processor of the apparatus 400, the instructions cause the apparatus 400 to perform a method for controlling a device. The method includes:

obtaining model identification information of a device to be controlled, wherein the model identification information is used for identifying a manufacturer and a device type of the device to be controlled;

obtaining a control interface for controlling a device of the device type manufactured by the manufacturer based on the model identification information; and

controlling the device to be controlled via the control interface.

Optionally, obtaining the model identification information of the device to be controlled includes:

sending to a server a query instruction including a user account;

receiving device information sent by the server, wherein the device information includes model identification information of devices associated with the user account; and

obtaining the model identification information of the device to be controlled that is selected by a user from a device list, wherein the device list displays the received device information.

Optionally, obtaining a control interface for controlling a device of the device type manufactured by the manufacturer based on the model identification information includes:

obtaining a control interface corresponding to the model identification information according to a correspondence relationship between model identification information and control interfaces.

Optionally, the model identification information includes at least information related to the manufacturer and information related to the device type of the device to be controlled.

Optionally, the model identification information further includes information related to a device model of the device to be controlled.

Optionally, the device information of devices associated with the user account sent by the server is determined by the server according to device information entered by the user, or is determined by the server according to received device information sent by the devices associated with the user account.

In embodiments of the present disclosure, a corresponding control interface is obtained according to model identification information of a device to be controlled. The model identification information is used for identifying a manufacturer and a device type of the device to be controlled. The control interface is used for controlling various functions of a device of the device type manufactured by the manufacturer. Thus, various functions of the device to be controlled may be controlled via the control interface.

Other embodiments of the present disclosure will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for controlling a device, comprising:
obtaining model identification information of a device to be controlled, wherein the model identification information is used for identifying a manufacturer and a device type of the device to be controlled;
obtaining a control interface for controlling a device of the device type manufactured by the manufacturer based on the model identification information; and
controlling the device to be controlled via the control interface.

2. The method according to claim 1, wherein obtaining the model identification information of the device to be controlled comprises:
sending to a server a query instruction including a user account;
receiving device information sent by the server, wherein the device information comprises model identification information of devices associated with the user account; and
obtaining the model identification information of the device to be controlled that is selected by a user from a device list, wherein the device list displays the received device information.

3. The method according to claim 1, wherein obtaining a control interface for controlling a device of the device type manufactured by the manufacturer based on the model identification information comprises:
obtaining a control interface corresponding to the model identification information according to a correspondence relationship between model identification information and control interfaces.

4. The method according to claim 1, wherein the model identification information includes at least information related to the manufacturer and information related to the device type of the device to be controlled.

5. The method according to claim 4, wherein the model identification information further includes information related to a device model of the device to be controlled.

6. The method according to claim 1, wherein the device information of devices associated with the user account sent by the server is determined by the server according to device information entered by the user, or is determined by the server according to received device information sent by the devices associated with the user account.

7. An apparatus for controlling a device, comprising:
a processor; and
a memory for storing instructions executable by the processor,
wherein the processor is configured to:
obtain model identification information of a device to be controlled, wherein the model identification information is used for identifying a manufacturer and a device type of the device to be controlled;
obtain a control interface for controlling a device of the device type manufactured by the manufacturer based on the model identification information; and
control the device to be controlled via the control interface.

8. The apparatus according to claim 7, wherein the processor is configured to:
send to a server a query instruction including a user account;
receive device information sent by the server, wherein the device information includes model identification information of devices associated with the user account; and
obtain the model identification information of the device to be controlled that is selected by a user from a device list, wherein the device list displays the received device information.

9. The apparatus according to claim 7, wherein the processor is configured to:
obtain a control interface corresponding to the model identification information according to a correspondence relationship between model identification information and control interfaces.

10. The apparatus according to claim 7, wherein the model identification information includes at least information related to the manufacturer and information related to the device type of the device to be controlled.

11. The apparatus according to claim 10, wherein the model identification information further includes information related to a device model of the device to be controlled.

12. The apparatus according to claim 7, wherein the device information of devices associated with the user account sent by the server is determined by the server according to device information entered by the user, or is determined by the server according to received device information sent by the devices associated with the user account.

13. A non-transitory computer-readable storage medium storing instructions that, when executed by a processor in an apparatus for controlling a device, cause the apparatus to perform a method comprising:
obtaining model identification information of a device to be controlled, wherein the model identification information is used for identifying a manufacturer and a device type of the device to be controlled;
obtaining a control interface for controlling a device of the device type manufactured by the manufacturer based on the model identification information; and
controlling the device to be controlled via the control interface.
